(19) United States
(12) Patent Application Publication
(10) Pub. No.: US 2023/0074477 A1
(43) Pub. Date: Mar. 9, 2023

(54) SYSTEM AND METHOD FOR OBJECT MONITORING, LOCALIZATION, AND CONTROLLING

(71) Applicants: Mohammad Shafikul Huq, HAMTRAMCK, MI (US); Shakura Quabili, HAMTRAMCK, MI (US)

(72) Inventors: Mohammad Shafikul Huq, HAMTRAMCK, MI (US); Shakura Quabili, HAMTRAMCK, MI (US)

(73) Assignees: Mohammad S Huq, Hamtramck, MI (US); Shakura Quabili, Hamtramck, MI (US)

(21) Appl. No.: 17/880,659

(22) Filed: Aug. 4, 2022

Related U.S. Application Data
(60) Provisional application No. 63/241,064, filed on Sep. 6, 2021.

(51) Int. Cl. G01S 7/41; G06T 7/73; B60Q 9/00; G01S 13/86; G01S 13/91

(52) U.S. Cl. CPC G01S 7/417; G06T 7/73; B60Q 9/00; G01S 13/865; G01S 13/867; G01S 13/91; G06T 2207/20084; G06T 2207/20081

(57) ABSTRACT

The present invention is a system and method to monitor, localize, and control objects in an implicitly defined geofenced area and to determine object position and orientation (vehicle only) by capturing the object's image, 3D data, or position using camera, LiDAR, and/or RADAR sensors that are installed on structures mounted on the ground. The sensors capture image, 3D data points, and distance of the surface points that are processed to ultimately obtain 3D data of the surface points of the object. The 3D data points from different sensors are then combined or fused by a controller to obtain a single set of 3D points, called fusion data, under one coordinate system such as the GPS coordinate system. The single set of 3D points is then processed by the controller using deep neural network and/or other algorithms to obtain position and orientation of the object. Additionally, the controller or sensors can send current and desired future object positions and orientations to controllable objects. Controller and/or sensors can send site image data to scene marking device and receive marked image data for geofenced monitoring of objects. Controller or sensors send alert to devices if objects are detected or abnormal behavior of objects are detected within the geofenced area.

### CROSS REFERENCE TO RELATED APPLICATION

This application is a continuation application of U.S. Provisional Patent Application No. 63/241,064, filed Sep. 6, 2021 with conformation number 9855, the contents of which are incorporated herein by reference almost in their entirety, with claims unchanged.

### FIELD OF THE INVENTION

The present invention relates to monitoring, localization, and controlling of objects using ground mounted sensors. If an object is not controllable, for instance a human being, the monitoring and partial localization (position only) is accomplished. The system has capability to do the monitoring within an implicitly defined geofenced area. For an object such as a vehicle that is controllable, localization and controlling is possible and is achieved through perception of the objects from ground mounted sensors. A vehicle may not have sensors to perceive the surrounding; even with sensors mounted on, a vehicle may not be able to perceive the surrounding of a particular place adequately so that it can determine its own position and orientation. The presented invention makes the determination possible using ground mounted sensors.

### BACKGROUND

Robotic control of an object needs the position and orientation, i.e. localization, of the object. Localization can be done using sensor data captured by the sensors mounted on an object itself and the map of the surrounding of the object. The sensor data delivered by sensors on the object may not capture enough data or the surrounding may not have enough features to capture so that localization can be performed reliably. If sensors are mounted on the ground or on structures on the ground at known positions, localization can be performed by capturing image, 3D surface points, and distances of the object.

In addition, monitoring of objects in geofenced area can be done by marking site images and letting the marked images known to a controller. Absolute positioning and controlling of a vehicle can be done by including three or more land mark points of known positions into the site and by sending current and desired positions and orientations of the vehicle to the vehicle controller. Sending the localization info, dimensions of the objects, and directions of travel to display devices such as mobile phone display or vehicle display can make an object aware of objects in the surroundings.

### BRIEF SUMMARY OF THE INVENTION

The present invention is a system and method to monitor, localize, and control objects in an implicitly defined geofenced area and to determine object position and orientation (vehicle only) by capturing the object's image, 3D surface data, or position using camera, LiDAR, and/or RADAR sensors that are installed on structures mounted on the ground. The sensors capture image, 3D surface data points, and distance of the surface points that are processed to ultimately obtain 3D data of the surface points of the object. The 3D data points from different sensors are then combined or fused by a controller to obtain a single set of 3D surface points, called fusion data, under one coordinate system, such as, the GPS coordinate system. The single set of 3D surface points is then processed by the controller using deep neural network and/or other algorithms to obtain position and orientation of the object. Additionally, the controller or sensors can send current and desired object positions and orientations to controllable objects. Controller and/or sensors can send site image data to scene marking device and receive marked site image data to be used for geofenced monitoring of objects. Controller or sensors send alert to devices if objects are detected or abnormal behavior of objects are detected within the geofenced area.

### BRIEF DESCRIPTION OF THE DRAWINGS

System and method of the present invention are illustrated as an example and are not limited by the figures of the accompanying diagrams and pictures, in which:

FIG. 1— FIG. 1 depicts a deployment scenario with various ground sensors, land mark points, scene marking device, geofenced area, etc.

FIG. 2-FIG. 2 depicts a diagram that describes how different devices, steps, and routines are connected and applied to perform the monitoring, localization, and control of objects as illustrated in the invention.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

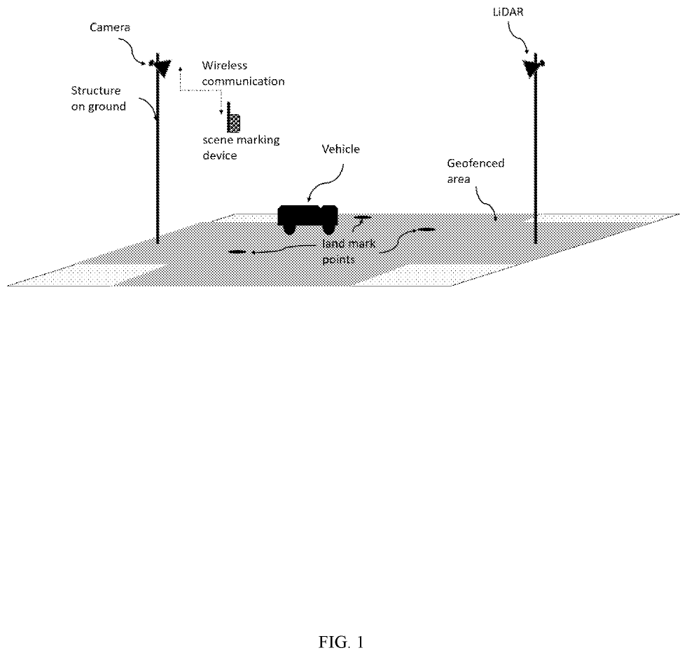

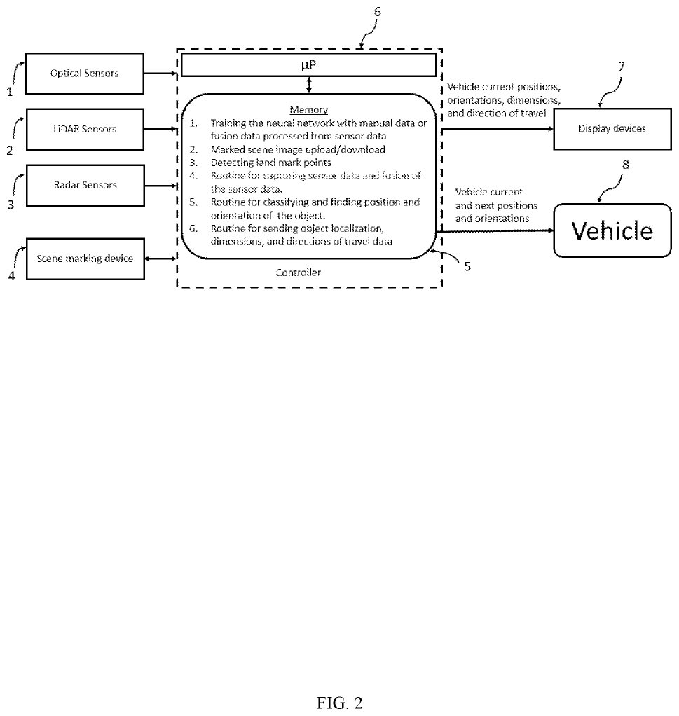

The present invention, a system and method for object monitoring, localization, and control will now be described by referencing the appended figures, FIG. 1 and FIG. 2, representing the preferred embodiments.

The present invention is a system and method to monitor, localize, and control objects in an implicitly defined geofenced area and to determine object position and orientation (vehicle only) by capturing the object's image, 3D data, or position using optical 1, LiDAR 2, and/or RADAR 3 sensors that are installed on structures mounted on the ground. The sensors capture image, 3D surface data points, and distance of the surface points of the object; all the captures are processed by a controller 6 with memory 5 to hold processing logics to ultimately obtain a more complete 3D data of the surface points of the object. The 3D surface data points from different sensors are then combined or fused by the controller to obtain a single set of 3D surface points, called fusion data, under one coordinate system such as the GPS coordinate system. The single set of 3D surface points is then processed by the controller using deep neural network and/or other algorithms to obtain position and orientation of the object.

Additionally, the controller or sensors can send current and desired future object positions and orientations to controllable objects such as vehicle 8. Controller and/or sensors can send their image data to scene marking device 4 and receive marked image data for geofenced monitoring of objects. Controller or sensors send alert to display devices 7 if objects are detected or abnormal behavior of objects are detected within the geofenced area.

1. A system to monitor, localize, and control an object by sensing the object with a plurality of optical, RADAR, and LiDAR sensors, where the sensors are mounted on structures on the ground at known locations, monitoring area can be marked for geofencing, and landmark points are used for positioning, with the system comprising:
a plurality of optical sensors, a plurality of RADAR sensors, and a plurality of LiDAR sensors mounted on structures on ground;
a controller to analyze data captured by the sensors, send vehicle control command to vehicles, and object information to display devices;
a plurality of devices receiving analytical information from the controller;
three or more landmark points with known positions visible in one or more scene images;
a scene marking device that can collect the said scene images, facilitate the capability to add additional information such as points, lines, and curves drawn on the images, and upload the additional information back into the controller and/or sensors; and
networked communication channels established among the sensors, controller, and devices.

2. The system as defined in claim 1, wherein the said locations are expressed in GPS coordinate system or in another coordinate systems common or accessible to all the sensors or the structures they are installed on;

3. The system as defined in claim 1, wherein a user can mark (manually or automatically) points and areas in the said site images in claim 1 and upload the site images back into the controller and/or sensors;

4. A method to monitor, localize, and control an object, the method comprising the steps:
capturing sensor data perceived by the ground sensors;
transferring the sensor data into the controller and scene marking device;
adding points, lines, and curves into the site images with scene marking device and uploading the marked site images into the controller and/or sensors;
processing all the data from different sensors to obtain position data of object surface points;
fuse the position data from different sensors into a common coordinate system known to all sensors, which is called fusion data;
using the fusion data or its projection in an already trained deep neural network or other algorithms such as computer vision algorithms to determine current object position and orientation;
sending current and future desired object positions and orientations to controllable objects;
sending said object positions, dimensions, orientations, and directions of travel into display devices; and
controller or sensors sending alert to devices if objects are detected or abnormal behavior of objects are detected within geofenced area.

5. The method as defined in claim 4, wherein the deep neural network is trained with manually prepared 2D or 3D structure data of multiple objects.

6. The method as defined in claim 4, wherein the deep neural network is alternatively trained with the fusion data.

7. The method as defined in claim 4, wherein the said object position and orientation can be determined by other means in addition to or without using deep neural network.

8. The method as defined in claim 4, wherein the display devices could be a stationary display device or a mobile one such as a cell phone screen or a display screen in a vehicle.
